(19) United States
(12) Patent Application Publication
(10) Pub. No.: US 2013/0060800 A1
(43) Pub. Date: Mar. 7, 2013

(54) SYSTEM FOR COMMUNICATING SUBSCRIBER MEDIA TO USERS OVER A NETWORK

(71) Applicants: Allon Caidar, San Diego, CA (US); Matthew Babineau, San Diego, CA (US)

(72) Inventors: Allon Caidar, San Diego, CA (US); Matthew Babineau, San Diego, CA (US)

(21) Appl. No.: 13/296,038

(22) Filed: Nov. 14, 2011

Related U.S. Application Data
(60) Provisional application No. 61/532,007, filed on Sep. 7, 2011.

(51) Int. Cl. G06F 17/30

(52) U.S. Cl. 707/758; 707/E17.01; 707/E17.108; 707/E17.009

(57) ABSTRACT

A system of selectively providing media as audio or video or combined media to users in a categorized highly segmented manner. Employing communications and operative software adapted to the task running on a networked computer or server, the system stores media files related to subscribing vendors. The media files are provided embedded with a media player forwarded to a user, or by communicating them to a user employing the media player on their local machine to request media files concerning a specific subscriber. Electronic sales leads are provided to the subscribing vendors through the employment of a relational database configured to discern potential user customers based on matching of media players requested or viewed by respective users which displayed media files related to the products or services sold by vendors.

This application claims priority to U.S. Provisional Application Ser. No. 61/532,007 filed on Sep. 7, 2011 and incorporated in its entirety by reference thereto.

### BACKGROUND OF THE INVENTION

1. Field of the Invention

The present invention relates generally to electronic media viewing and communication. More particularly it relates to a system and method for disseminating stored media for subscribers over a network such as the internet employing customized media players specific to the subscriber. The customized media players employ categorized menus for playing and searching the respective subscribers' media, and are communicated to requesting users in a customized digital format determined as employable by the display device of the remote requesting user.

2. Prior Art

In recent years, the ability of users to communicate over the internet and receive and display media in the form of audio and video has advanced tremendously. In the early years bandwidth was a major problem for transmission of media to user computers as broadband service was rarely available. Not only did this require extensive and time-consuming compression of media files sent from servers, the slow nature of user computers and transmission rates further inhibited such communication.

An additional problem which ensued is that media was, and still is, available in many digital formats. Combined with the many formats of file compression and transmission, a problem began in that a simple video to be viewed on a user computer, needed to be available on the server accessed by the user in a high number of formats to accommodate the different types of computer operating systems used by users as well as the different types of viewing systems and software each such user might have on their respective computer.

In recent years, the availability of low cost broadband internet service has become widespread. Media which used to take an hour for transmission from a server to a user device, now takes minutes or seconds. With this revolution in cost, transmission capability, and speed, has come a widespread user demand for media such as video with audio in a digital format on an infinite number of subjects.

However, as technology has improved with broadband transmission, so has it improved with user viewing devices. In earlier years file transmission of media was generally a choice between audio and video capable of user employment on the APPLE or WINDOWS operating systems. With these two operating systems a few types of standardized media playing and displaying software were developed and/or widely user employed.

In more recent years, with the advent of PDA's, tablet computers, smart phones, game devices, and other computing devices capable of internet communication and onboard data processing sufficient for media display, another problem has arisen. There are numerous operating systems for such game playing devices, and smart phones, and PDA's, and other fixed and mobile computing devices. Along with the numerous operating systems, has arisen numerous applications and programs which render video and sound on the user's device working in concert with the operating system. Thus, whereas encoded video years ago might be transmitted slowly to a home computer, using one of two major operating systems, today, there are numerous ways the video itself may be digitally stored, and a plethora of combinations of operating systems and onboard rendering software to which the video or media might need to be communicated.

This ongoing expansion of operating systems, devices, bandwidth, and availability, has created a new problem for companies who might benefit from informational and advertising media being made available to millions of users connected online. Most retailers and commercial companies are not adept computer programmers as that is not their core business. Consumers on the other hand are becoming more and more sophisticated about how they access, shop for, and research products and services. Consequently consumer users, with the ability to receive media on their local computing device, seek out video and audio playable locally regarding products and services sold by companies.

Companies being adept at retailing and promoting services, have a choice. They must either host their own servers with huge amounts of stored data and media files, with a high number of differing formats for each such file, in order to try and provide users with widely varying computing devices using varying operating systems and rendering software, or they must sub contract this task to outside firms who may or may not be adept at providing users the proper media in the proper format at a bandwidth which the user's device may employ to render the video locally for viewing.

A further problem exists whether companies handle such media communication and transmission themselves, or have such handled by contractors. There is no standardized uniform manner to offer users vendor-specific content where users can ascertain by category what is available from a specific vendor of products and services, and thereafter choose the media they wish communicated from such a category. Neither is there any recognizable format to provide such a categorization system and data file delivery.

Consequently, large and small companies and retailers who are willing to provide consumer users with highly pertinent information about products and services, are going to great expense to do so with less than stellar results. This is because consumer users at each website, must ascertain where the communicable media actually resides, and then tunnel through numerous pages to find it. On each website the process may be different depending upon the initial programming.

For example, a large retailer of home improvement goods displays a website accessible by anyone. Users interested in the firm's products must navigate to the website first, and then ascertain the type of menu and product information provision system the specific website is offering. It is a learning process for each site visited by a user since there is no common format for product and service vendors to offer. If the user finds what they are looking for, and leaves the site, and visit the site again, subsequently, they must hope the site is organized the same, or start the process anew. Should they wish to tell a friend about a discovered product or service, the best they might do is email a link to the site, and if organized to accept it, a link to a spot on the site.

Since users with a specific interest or skill or hobby, tend to know other users with the same interests, they frequently have the same leanings in purchasing products and services. However, in order to inform another user about a product or service available from a company, as noted, currently the best a user might do is send a message with a hyperlink to a web page of common interest, the friend, so informed, must repeat the previous user's learning curve on visiting the recommended site.

If companies had a means to provide users with an easy-to-use system, employing a common format for user information lookup, which standardized both the viewing area and menus, and which also employs software adapted to ascertain the user's device and rendering requirements to deliver the media in a proper useable format, both users and companies would be well served. Users would immediately recognize the location of categorized information for the company of interest and be able to easily navigate and request the information they require. If such a system employed an electronic container, so to speak, for the information relevant to each respective individual subscribing company, one user instead of forwarding a link to a site, could forward the entire electronic container for the information available from a specific vendor. Consequently, such a system would render the dissemination from user to associated user, for information from individual companies of common interest, easy to accomplish. Further, this standardized container and categorical information delivery system, featuring individual vendors for products and services in each electronic container or player, the system would serve to promote vastly increased dissemination of the media from the subscribing company, and increased sales.

As such, in the modern era of the internet and broadband, what is needed is a common recognizable system for delivery of listings of available media to users, relating to individual respective companies and providers of services and products. Such a system should employ a player or electronic packaging of the respective seller's media available by category to users, and thereafter by actual media files related to the chosen category. Such a system should be useable at kiosks or on user smart phones and devices the company's stores, online, and be forwardable from one user to the next for employment on their respective computing device. Still further, such a system should employ an interface, which during the start of a user session, ascertains the type of media player employed by the respective user, and the electronic file requirements for the discerned device to render the media useable by the user's device. Once discerned, the system should assign an identifier to the device on which the player resides, and relate that to media file requirements for future transmission to the device. Finally, such a system should allow the company itself to send out electronic players acting as containers for the categorized information, or to subcontract the task and always have a uniform manner of delivery to users so they may easily find the media they require if it is available. One object of the present invention is to also provide such media and information categorically relevant to each subscribing firm's products and services containerized to users in a manner which would be detectable by conventional standards of internet search engines so users seeking the information contained may find it using such search engines which would provide links to the appropriate container of categorized information relevant to their search.

### SUMMARY OF THE INVENTION

The present invention provides a system and apparatus for the storage, organized offering, and provision of media in the form of videos and audio to desiring users on a network such as the internet. The system provides for a standardization of the available media from or regarding a specific provider of products or services. This standardization is accomplished in a software-operated virtual media player which provides a graphically depicted viewing screen and a common or a standardized manner of providing the user a menu of available viewable media. The player is employable by the user on kiosks, on their own computing device, or over the internet from a server or cloud-based system.

The player provided acts as an electronic container for all of the media available from a specific vendor of products and/or services. Thus a user interested in a number of different vendors can maintain individual players on their computing devices and know that the media provided thereby and displayed thereby, is specific to a vendor of their choosing. While it is envisioned that one player might provide media menus for multiple product and service vendors, it is preferred to render each player in a manner specific to a particular vendor of products and services.

The specificity is preferred for a number of reasons, first of which is the sophistication of users. Many users are incapable of adapting software or media players to different situations or unable to easily ascertain menu functions. By distributing players which are specific to particular vendors, the user knows the menus are specific to products and services they desire from that specific vendor. Secondly, by rendering the players specific to vendors, with onboard categorized standardized menus, it renders the media players themselves to be transportable and forwardable as an executable unit over the internet. Thus it encourages individual users who know other users with similar interests, to send them the player that is specific to a vendor of common interest, and know their friend will be getting relevant information in a standardized format and not junk mail or scams or players which contain information in which their friends would lack interest. Further, to business subscribers to the service, a player rendering and only offering their respective products and services insures their competitors products and services are not also included or added.

Standardization and limiting viewable media to one purveyor or product has other benefits in the area of data/metrics. Currently one manner of providing vendors with leads for customers employs a tracking of the web surfing habits of individual users. The information provided is based on categorizing a tracked user's video viewing habits at numerous sites of numerous interests and by interest/genre/etc.

Conventional sellers of user locations and electronic addresses for popup and pushed advertising is based primarily on what sites a user visits and not what the user does there. Rather than discerning potential customers for product and service vendors based on a user's web surfing habits and patterns based solely on tracking of a user visiting websites, the system herein allows the system operator to tell advertisers what video the users watched, and what specific subject and media were included in requested and played media players. This is a technique which yields relational data on internet users which is very different and much more accurate of what a user is currently considering for purchase. Consequently, such information is valuable when subsequently determining which video ad to serve or popup on the screen of such a user.

The system herein achieves this unique and more accurate customer profile because the system operator communicates the various media players with categorized information related thereto to each users. Thus, data can be collected as to exactly what media is being requested by individual users, and viewed on the media players. Further, in addition to tracking each requested media player and relating it or a group of players to a specific user in a user database, optionally the system herein may employ specific media player-based cookies to communicate to the system operator if a unique user was on a specific player. For example the communicated cookie could provide information that a user who viewed player X was also on players Y,Z,C, and D. Therefore potential advertisers can be sold information on what specific users like to watch on video when they are online, or what media they are requesting, and not just which website they may or may not have visited.

With respect to the above description, before explaining at least one preferred embodiment of the herein disclosed invention in detail, it is to be understood that the invention is not limited in its application to the details of construction and to the arrangement of the steps in the following description or illustrated in the drawings. The invention herein described is capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other electronic and software enabled media player related distribution and methods and systems for carrying out the several purposes of the present disclosed system. It is important, therefore, that the claims be regarded as including such equivalent construction and methodology insofar as they do not depart from the spirit and scope of the present invention.

It is an object of the invention to provide a web-based provision of media, specific to subscribers, to users having interest in the respective subscriber's products or services.

It is another object to provide such media to users along with a software player adapted to play the media on the respective user's display device.

It is yet another object of this invention to provide such media dissemination for subscribers, in a fashion which also includes categorized menus for playable media thereby improving ease of section of the desired media by the remote user.

Yet an additional object of the present invention is the provision of a plurality of individual increments of media and information, relevant to an individual, a firm, or a location, in a categorized fashion relating to each subscribing firm's products and services, in a manner easily discoverable by conventional search engines.

Further objectives of this invention will be brought out in the following part of the specification wherein detailed description is for the purpose of fully disclosing the invention without placing limitations thereon.

### BRIEF DESCRIPTION OF DRAWING FIGURES

FIG. 1 is a block diagram of the disclosed system for communicating media such as video and audio to users in accordance with one embodiment of the present invention.

FIG. 2 is an extension of the diagram of FIG. 1.

FIG. 3. depicts a rendering of a media player's screen, and a means for ascertaining if an identified player has been syndicated to a subsequent machine and the potential that a capability inventory of the subsequent machine may be employed.

FIG. 4 depicts a vendor-specific media player exemplar.

FIG. 5 shows the categorization of the provided players.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

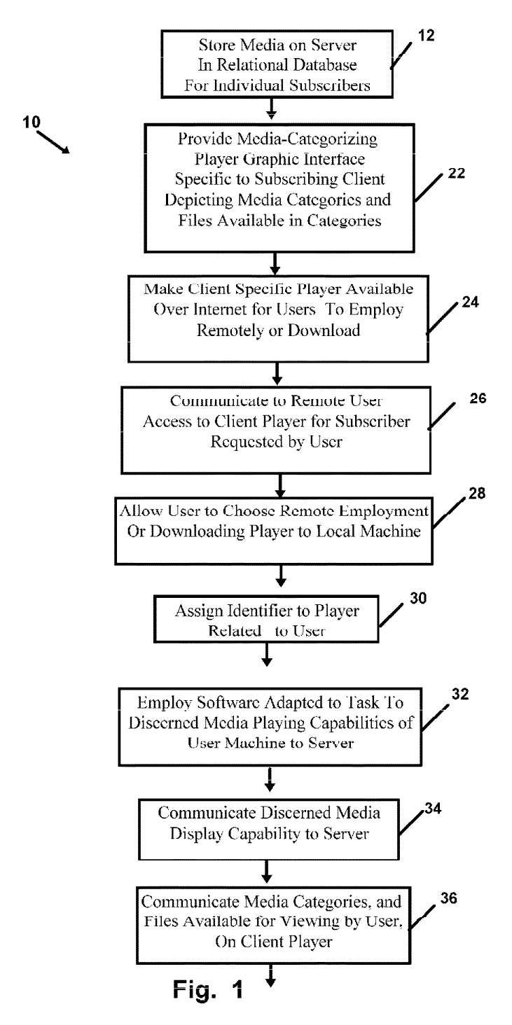

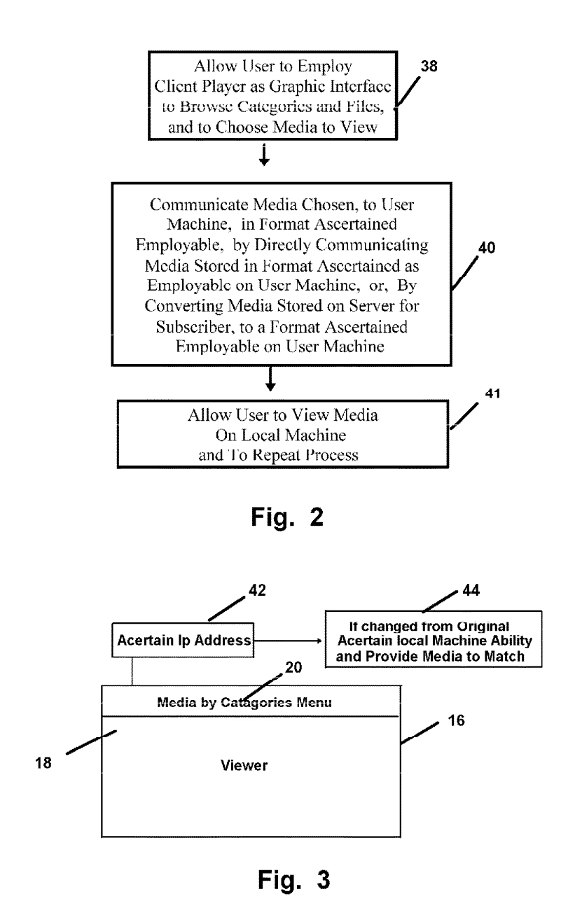

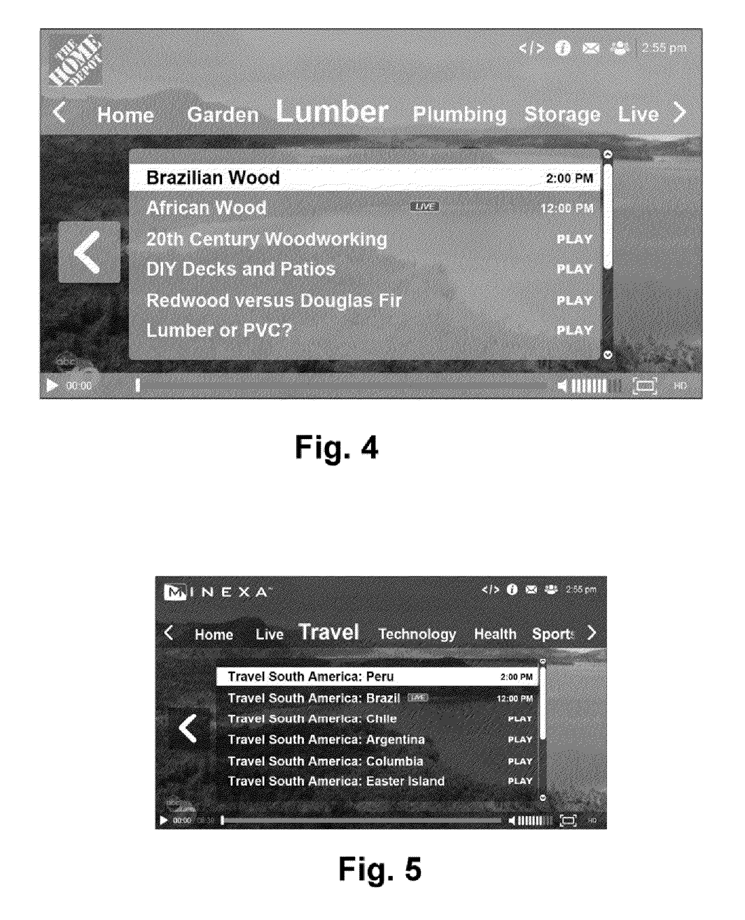

Now referring to drawing, in FIGS. 1-5, there is shown a block diagram, figures representative of the disclosed system 10 for communicating media such as video and audio to users in accordance with the primary objectives of the present invention. Those skilled in the art will realize that the order may be changed, rearranged, or other steps inserted and the system 10 will still provide a substantial improvement to the provision of media in a categorized fashion and any such modification is anticipated within the scope of this invention.

In operation, for respective subscribers, the system 10 in a first step 12 will electronically store, and make accessible through a network-accessible server, accessible by users and search engines, media files relating to the products and/or services of each respective subscriber. The individual media files may be stored on the server and later requested by user-activation of a media player, or, they may be communicated to users as a grouping of files adapted to be accessed by the media player 16 (FIG. 3) once installed on the user computing device.

Also in the first step, software adapted to the task, will electronically containerize with a media player 16, or provide a user activated link to a download or a streaming of the categorized files, communicable with or to the media player 16.

In either manner, each respective subscriber's media files, categorized by subject or other with some other category identifiers, are provided to the user in a choosable fashion, to allow the user requesting the information and media player 16, to easily find and use the media files most specifically related to their desire or inquiry for information at the moment.

The file categorization is discernable on the user's computing device display, by a user who requests the media files, by viewing a graphic display area shown as virtual display screen 18 FIG. 3, in a depiction therein using indica 20 such as text and photos or other indicia means which are discernible by a user as categories, and the underlying media files related to chosen categories.

Additionally, the media players 16 made available for download, as well as the server providing access to them, also employ meta-data and other conventional content markers, as a means for which to allow conventional search engines to identify and thereafter ascertain the categories and subject matter contained or related with any respective player 16. The meta data can provide information by category and media files available in such categories or combinations thereof and may contain hypertext allowing direct links to view or download said media files.

With the media files containerized and/or associated with and available for communication to an individual respective media player 16, the media players 16 specific to a subscribing client are stored in an accessible fashion 22 on an internet-connected server. Here the metadata can be included to allow search engines to easily find the media players and categorized files and information related to each.

In a next step, the client specific media players are made available for use and/or download and use by users 24 requesting such after a search engine search, or, after visiting the subscriber's website and requesting the information thereon and being linked to the server hosting the players 16. Alternately, the players 16 with categorized communicable files can be loaded to the subscriber's server for user access, or communicated to in-store kiosks or video displays which are operatively engaged to a data processor and electronic communications. These in-store venues will be accessible by users on-site where the user may immediately view the content of a chosen media player 16, or may request an electronic forwarding of the media player 16 chosen to their email or electronic destination for later viewing, or both.

Once the media players 16 specific to the subscriber are made available for users, and a user requests such, through a hypertext or hot link or other means of electronic designation, the access to the media player 16 desired by the user for the subscriber's products or services, is communicated to the user 26 electronically. Thereafter, the user may choose how they access the media player 16 of choice, 28, by allowing a download of the media player 16 with links and/or associated files embedded therewith, or by allowing the user to remotely run the media player 16 virtually through a link from the user's computer to the server hosting it, or as noted above through on-site venues and/or email or other electronic communication to a user-designated electronic destination.

The requesting user in each case, is assigned a user identifier 30 which may be ascertained by software operating on the system. The identifiers 30 assigned will be unique to each requesting user and each player 16 provided pursuant to their request which will be associated with the user requesting it.

Once the media player 16 is assigned an identifier 30 and either downloaded, forwarded to a user-chosen electronic destination, or remotely operated by the user associated with it with their own identifier, software adapted to the task identifies the media playing capabilities of the user's local machine 32 and the software-discerned media display and audio playback capabilities of the local machine 32 are then communicated to the server 34 hosting the communicated files.

Thereafter the user employs the communicated media categories and underlying media files, to ascertain which media files the user wishes to employ on their local machine 36. This can easily be accommodated by allowing the user to employ the communicated media player 16 as a graphic interface 38 menu and allow the user to browse the categories and underlying related media files and thereby choose the media they wish to view.

Once the user communicates their choices, using software adapted to the task, the providing server uses the ascertained user machine media playing capabilities associated with the user, to provide the user-desired media files, in a format which can be employed on the requesting user's local machine 40. This can be done by allowing a communication and download of the media files to storage on the user's machine, or by streaming the media files to the user machine from the hosting server, or in another fashion allowing the user to view the media on their local machine 41.

In any case, the user and the media player being both individually identified, and both assigned respective relating identifiers, the media provided thereafter to the user is done in a format and file configuration to allow for media playing locally on the user's machine using the discerned local media capabilities.

In an optional but preferred mode of the system 10, the communicated media players 16 will be made freely electronically communicable for sharing or syndication by the possessing identified user, to other new users for use on their respective local machine. As shown in FIG. 3, with this option enabled, the media player 16 upon being communicated and activated on a new local machine can just contact the server and employ its unique media player identifier to receive and play media. Optionally, the media play may have software adapted to the task to ascertain if it's in a new location by identifying the local IP address 42, or the MAC ID on the local machine's network card, and compare the identified information against stored information of the local machine the media player occupied previously. In a preferred mode, the software running with the media player, will simply communicate its assigned identifier to the hosting server. Each version of the syndicated media player, having the original identifier, will receive access to the same electronic media that was delivered with the original player and such media is made available by software on the server communicating with the media player ascertaining the media player identifier which is then cross referenced with the media to be made available to the identifier found on the media player.

The media player may be configured employing software adapted to the task, to allow the user receiving it to customize it by changing one or both of the graphic display area shown as virtual display screen 18 in FIG. 3 and/or the graphic display area or the graphic interface 38 menu. Using a graphic interface such as WINDOWS and configuring the media player to allow such changes will allow users to mold or meld the media players to their personal likes.

As noted in FIG. 3 and above, software adapted to the task can ascertain local location and machine identifiers such as the IP address and/or the MAC Id of the local network card. Software adapted to the task running on the media player or server would then determine, based on the IP address location and earlier user identifier matched to the media player identifier, if the media player 16 is being hosted on the same local machine 44. Once the IP address of the local machine the media player occupies is discerned, the server employing software adapted to the task can tailor and restrict access to media based on the discerned IP address, and the particular identified machine that is viewing the player. Such information may be stored in a relational database and employed in communications subsequent, to subscribers having products relating to the media players, or to advertisers or sellers or third parties selling such products or services or related secondary products and services. These communications to subscribers, and especially to third party sellers and advertisers who are not subscribers, would be electronically configured with sufficient information on how the user can be electronically communicated with for advertising purposes.

This process may be employed for example, to manage content rights of the media which may be territory-specific. Or, perhaps the media being communicated to the player concerns a particular retailer with many local stores. The IP address employing software adapted to the task running on the server, can ascertain that vendor's local sales or other local media material concerning the vendor or retailer and thus the communicated media may be tailored to the user at the IP address identified new location.

If the player 16 has been moved to a new machine, for instance by being sent by one person to a friend or relative user, such can be discerned by the IP address and the local machine/user identifier being matched with the identifier assigned the media player 16. As noted above, the media player identifier serves to identify the media that is communicated to each media player and all would have access to such based on the media player identifier. However, once a new location is determined, then software adapted to the task could be employed to discern media playback capabilities on the local machine 32, and assign an identifier to the local user and if desirable, a new identifier to the media player in a similar step to the earlier step 30. Thereafter the new user will have their own identifier associated with the new location and capabilities of the machine at the new location.

The ability for users to electronically forward the media player 16, which is configured with subscriber-specific products and services made available in a categorized fashion based upon the media player identifier, and having software which then self-ascertains a media player's new location and local machine abilities, is a significant step forward in ongoing marketing for subscribers products and services. This is because many users and groups have common interests and they will freely forward the media players 16 housing media related to their common interests to like-minded users who will appreciate the highly specific products and services associated with it and be more likely to order and to themselves, forward the media player to others of similar interests. Once forwarded to a new machine, the new user is provided with access to the same media files the media player identifier allows and the new user is either identified as currently in the database, or a new user record is placed in the relational database to relate the medial players and media being requested and/or watched by individual users. When it is determined a media player has changed users, the provided media files communicated to the subsequent user, while being the same subject matter as the prior user, may be adapted for run on their local machine by inventorying the hardware and software of the local machine without any prompting.

By standardizing the media provided and related to any individual media player, and relating the media players to users, much more accurate user information is generated than by conventional simple tracking website visited. Consequently limiting viewable media to one purveyor or product provides valuable user data in the area of data/metrics.

The system herein, provides relational user information concerning what video the users watched, what friends were forwarded that video or media and if they watched it, and what specific subject and audio or visual media were included or communicated to the specific media players requested or watched.

Thus by limiting the media each media player plays, and by tracking each individual user in a relational database which maintains current and past listings of media players requested and watched by each user, they system herein yields relational data on internet users which is highly specific on their current interests and which may be provided to advertising subscribers as a means to determine what media to push or send to the user with concern to products or services. Rather than guess why the users visited a website in sending them advertisements, the system herein using highly specific media players with limited products and services thereon, can target tracked users for upcoming purchases much more accurately for advertisers. This tracking information may be enhanced by inclusion of a tracking cookie with requested or forwarded media players which would render reports on which media players or what plurality of media players a user has received and watched.

While all of the fundamental characteristics and features of the player-based media communication system herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful system, various substitutions, modifications, and variations may occur to and be made by those skilled in the art without departing from the spirit or scope of the invention. Consequently, all such modifications and variations and substitutions, as would occur to those skilled in the art are considered included within the scope of the invention as defined by the following claims.

What is claimed:

1. A method for storing electronic media such as video and audio for subscribers, and communicating said media to users comprising the steps of:
storing media files in subscriber directories related to individual subscribers on a computerized server in a network of servers, said server being accessible by users over the internet;
allowing users to employ a user electronic device having means to display video, to initiate a communication with said server;
employing software adapted to communicate an interface to said users allowing said users to communicate a selection of a subscriber from said subscribers having said electronic media stored on said server;
subsequent to said selection, employing software adapted to the task, to ascertain a useable electronic format for said user electronic device, with which said media files may be electronically employed locally, to display video and/or play audio on said user electronic device;
communicating a media player from said server, to said user electronic device of said user, in said useable electronic format;
configuring said media player communicated with a graphic display area and a graphic interface menu area providing means for said user to search a said directory listing said media files relating to products or services of said chosen subscriber for said media files available therein;
configuring said graphic interface of said menu area to provided means for said user to select a chosen said media file to be played by said media player on said user electronic device;
employing software adapted to the task of communicating said chosen media file from said server to said user electronic device; and
allowing said user to repeat the steps herein.

2. The method of claim 1, additionally comprising:
configuring said media player communicated to said user, as an executable software file;
allowing said user to electronically store said media player related to said subscriber on said user electronic device;
allowing said user to repeat the steps of claim 1 employing said media player stored electronically on said user electronic device.

3. The method of claim 1, additionally comprising:
communicating said media player communicated to said user, as an executable software file;
allowing said user to electronically store said media player related to said subscriber on said user electronic device; and
allowing said user to repeat the steps of claim 1 employing said media player stored electronically on said user electronic device and adapting said media player to allow the user to utilize the video and/or audio playback capabilities of a separate media player that is pre-existing on said user electronic device.

4. The method of claim 1, additionally comprising:
communicating said media player to users in an electronically forwardable format;
allowing a said user receiving said media player to forward said media player as a forwarded media player to a subsequent user;
allowing said subsequent user to electronically store said media player related to said subscriber on a subsequent electronic device being employed by said subsequent user; and
allowing said subsequent user to repeat the steps of claim 1 employing said forwarded media player stored electronically on said subsequent user's electronic device.

5. The method of claim 1, additionally comprising:
assigning a unique user identifier to each said user; and
storing said identifier in a relational database relating said user identifiers to respective said users.

6. The method of claim 5, additionally comprising:
assigning a unique player identifier to each said media player communicated to a respective said user; and
storing said player identifier in said relational database in a relation to a respective said user identifier of a user receiving it.

7. The method of claim 6, additionally comprising:
providing said subscribers user-targeting information for a subsequent communication of electronic advertising of said subscriber's products or services by employing software to mine said relational database for matches between specific said users who have been communicated a said media player relating to said products or services of said subscriber.

8. The method of claim 6, additionally comprising:
determining a third party, such as a seller or an advertiser for said products or services or secondary products and secondary services, who is a non-subscriber;
employing software to mine said relational database for matches between specific said users who have been communicated a said media player relating to said products or services of a said subscriber which are related to said secondary products or said secondary services; and
providing said user-targeting information to said third party, said user-targeting information configured electronically with sufficient user contact information to provide said third party means to communicate a subsequent communication of electronic advertising of said products or services, or of said secondary products or secondary services.

9. The method of claim 1, additionally comprising:
employing software adapted to the task, to configure said media player communicated to a said user to allow said user to customize one or both of said graphic display area and said graphic interface menu.
